(19) United States
(12) Patent Application Publication
(10) Pub. No.: US 2017/0061992 A1
(43) Pub. Date: Mar. 2, 2017

(54) MULTI-LAYER STUDS FOR ADVANCED MAGNETIC HEADS AND HIGH HEAD DENSITY WAFERS

(71) Applicant: HGST Netherlands B.V., Amsterdam (NL)

(72) Inventors: Andrew Chiu, San Jose, CA (US); Matthew W. Last, San Jose, CA (US); Edward H. P. Lee, San Jose, CA (US); Michael M. H. Yang, Campbell, CA (US)

(21) Appl. No.: 14/841,580

(22) Filed: Aug. 31, 2015

(51) Int. Cl. G11B 5/127; G11B 21/02

(52) U.S. Cl. CPC G11B 5/127; G11B 21/02

(57) ABSTRACT

In one embodiment, a system includes a wafer and a plurality of contact pads positioned on the wafer. Each contact pad includes a multi-layer stud and a cap layer. The multi-layer stud includes at least a bottom layer and a top layer, the bottom layer being positioned on and extending from an upper surface of the wafer substantially in a direction perpendicular to the upper surface of the wafer, and the top layer being positioned above the bottom layer and substantially extending in the direction perpendicular to the upper surface of the wafer. The cap layer is positioned on the top layer of the multi-layer stud and extends beyond sidewalls of the multi-layer stud substantially in a direction parallel to the upper surface of the wafer. The bottom layer has a larger cross-sectional area than any layer of the multi-layer stud positioned thereabove.

### FIELD OF THE INVENTION

The present invention relates to data storage systems, and more particularly, this invention relates to pad layout and design for magnetic head and small scope electronic device testing.

### BACKGROUND

The heart of a computer is a magnetic hard disk drive (HDD) which typically includes a rotating magnetic disk, a slider that has read and write heads, a suspension arm above the rotating disk and an actuator arm that swings the suspension arm to place the read and/or write heads over selected data tracks on the rotating disk. The suspension arm biases the slider into contact with the surface of the disk when the disk is not rotating but, when the disk rotates, air is swirled by the rotating disk adjacent an air bearing surface (ABS) of the slider causing the slider to ride on an air bearing a slight distance from the surface of the rotating disk. When the slider rides on the air bearing the write and read heads are employed for writing magnetic impressions to and reading magnetic signal fields from the rotating disk. The read and write heads are connected to processing circuitry that operates according to a computer program to implement the writing and reading functions.

The volume of information processing in the information age is increasing rapidly. In particular, it is desired that HDDs be able to store more information in their limited area and volume. A technical approach to meet this desire is to increase the capacity by increasing the recording density of the HDD. To achieve higher recording density, further miniaturization of recording bits is effective, which in turn typically requires the design of smaller and smaller components, such as magnetic heads and the associated components of magnetic heads.

The further miniaturization of the various components, however, presents its own set of challenges and obstacles. Each magnetic head includes a set of pads for testing the components of the magnetic head prior to use in a HDD. As additional components, such as heaters, near field transducers, etc., are added to layouts for single and multiple magnetic head designs to allow for the further miniaturization of recording bits of the magnetic media, additional pads are needed to test the additional heads and components. This increase in the number of pads required to test each magnetic head and its components decreases a maximum size of each pad.

During conventional formation of these pads, an overcoat deposition creates dielectric seamlines near the studs of each of these pads. These seamlines are formed due to the multiple layers of dielectric which are formed in successive deposition operations, where a minimum thickness of the dielectric layer is formed near the creases around the bottom of each stud. When these seamlines are not encapsulated by upper conductive pads, then a phenomenon referred to as trailing edge alumina defect (TEAD) is possible, which leads to reliability issues and premature failure, and is common when the surface area of the pads is reduced to fit more pads in the layout.

### SUMMARY

In one embodiment, a system includes a wafer and a plurality of contact pads positioned on the wafer. Each contact pad includes a multi-layer stud and a cap layer. The multi-layer stud includes at least a bottom layer and a top layer, the bottom layer being positioned on and extending from an upper surface of the wafer substantially in a direction perpendicular to the upper surface of the wafer, and the top layer being positioned above the bottom layer and substantially extending in the direction perpendicular to the upper surface of the wafer. The cap layer is positioned on the top layer of the multi-layer stud and extends beyond sidewalls of the multi-layer stud substantially in a direction parallel to the upper surface of the wafer. The bottom layer has a larger cross-sectional area than any layer of the multi-layer stud positioned thereabove.

In another embodiment, a method includes forming a bottom layer of a multi-layer stud for each of a plurality of contact pads above a wafer. The bottom layer is positioned above and extends from an upper surface of the wafer substantially in a direction perpendicular to the upper surface of the wafer. The method also includes forming at least one additional layer of the multi-layer stud, including a top layer, above the bottom layer for each of the plurality of contact pads. The top layer is positioned above the bottom layer and extends substantially in the direction perpendicular to the upper surface of the wafer. The method also includes forming a cap layer positioned on the top layer of the multi-layer stud for each of the plurality of contact pads, the cap layer extending beyond sidewalls of the multi-layer stud substantially in a direction parallel to the upper surface of the wafer. The bottom layer has a larger cross-sectional area than any layer of the multi-layer stud positioned thereabove.

Any of these embodiments may be implemented in a magnetic data storage system such as a disk drive system, which may include a magnetic head, a drive mechanism for passing a magnetic medium (e.g., hard disk) over the magnetic head, and a controller electrically coupled to the magnetic head.

Other aspects and advantages of the present invention will become apparent from the following detailed description, which, when taken in conjunction with the drawings, illustrate by way of example the principles of the invention.

### BRIEF DESCRIPTION OF THE DRAWINGS

For a fuller understanding of the nature and advantages of the present invention, as well as the preferred mode of use, reference should be made to the following detailed description read in conjunction with the accompanying drawings.

FIG. 1 is a simplified drawing of a magnetic recording disk drive system, according to one embodiment.

FIG. 2A is a cross-sectional view of a perpendicular magnetic head with helical coils, according to one embodiment.

FIG. 2B is a cross-sectional view a piggyback magnetic head with helical coils, according to one embodiment.

FIG. 3A is a cross-sectional view of a perpendicular magnetic head with looped coils, according to one embodiment.

FIG. 3B is a cross-sectional view of a piggyback magnetic head with looped coils, according to one embodiment.

FIG. 4 is a schematic representation of a perpendicular recording medium, according to one embodiment.

FIG. 5A is a schematic representation of a recording head and the perpendicular recording medium of FIG. 4, according to one embodiment.

FIG. 5B is a schematic representation of a recording apparatus configured to record separately on both sides of a perpendicular recording medium, according to one embodiment.

FIG. 6A is a cross-sectional side view of a contact pad according to one embodiment.

FIG. 6B is a cross-sectional side view of a contact pad according to one embodiment.

FIGS. 7A-7D show various cap layer and top layer cross-sectional top profiles according to multiple embodiments.

FIGS. 8A-8C show systems with exemplary contact pad layouts, according to various embodiments.

FIG. 9 shows a cross-sectional side view of three contact pads, according to one embodiment.

FIG. 10 is a flowchart of a method according to one embodiment.

### DETAILED DESCRIPTION

The following description is made for the purpose of illustrating the general principles of the present invention and is not meant to limit the inventive concepts claimed herein. Further, particular features described herein can be used in combination with other described features in each of the various possible combinations and permutations.

Unless otherwise specifically defined herein, all terms are to be given their broadest possible interpretation including meanings implied from the specification as well as meanings understood by those skilled in the art and/or as defined in dictionaries, treatises, etc.

It must also be noted that, as used in the specification and the appended claims, the singular forms “a,” “an” and “the” include plural referents unless otherwise specified.

Several terms used herein are now clarified. “About” as used herein indicates a value which follows the term “about,” and all values that are approximately the value. In one embodiment, “about” indicates the value and plus or minus 5% of the value, e.g., “about 10 μm” is satisfied by all values including 9.5 μm up to and including 10.5 μm. Furthermore, “substantially” as used herein indicates the term which is preceded by “substantially” to the best ability and precision of the manufacturing and formation processes which are used to accomplish the term, e.g., “substantially perpendicular to plane A” is satisfied by whatever manufacturing tolerances of producing a shape in a direction normal to the plane A allow, such as within 0.5%, 1%, 2%, etc., depending on the manufacturing process and what one of skill in the art would understand the manufacturing tolerances to be.

The following description discloses several preferred embodiments of disk-based storage systems and/or related systems and methods, as well as operation and/or component parts thereof.

In one general embodiment, a system includes a wafer and a plurality of contact pads positioned on the wafer. Each contact pad includes a multi-layer stud and a cap layer. The multi-layer stud includes at least a bottom layer and a top layer, the bottom layer being positioned on and extending from an upper surface of the wafer substantially in a direction perpendicular to the upper surface of the wafer, and the top layer being positioned above the bottom layer and substantially extending in the direction perpendicular to the upper surface of the wafer. The cap layer is positioned on the top layer of the multi-layer stud and extends beyond sidewalls of the multi-layer stud substantially in a direction parallel to the upper surface of the wafer. The bottom layer has a larger cross-sectional area than any layer of the multi-layer stud positioned thereabove.

In another general embodiment, a method includes forming a bottom layer of a multi-layer stud for each of a plurality of contact pads above a wafer. The bottom layer is positioned above and extends from an upper surface of the wafer substantially in a direction perpendicular to the upper surface of the wafer. The method also includes forming at least one additional layer of the multi-layer stud, including a top layer, above the bottom layer for each of the plurality of contact pads. The top layer is positioned above the bottom layer and extends substantially in the direction perpendicular to the upper surface of the wafer. The method also includes forming a cap layer positioned on the top layer of the multi-layer stud for each of the plurality of contact pads, the cap layer extending beyond sidewalls of the multi-layer stud substantially in a direction parallel to the upper surface of the wafer. The bottom layer has a larger cross-sectional area than any layer of the multi-layer stud positioned thereabove.

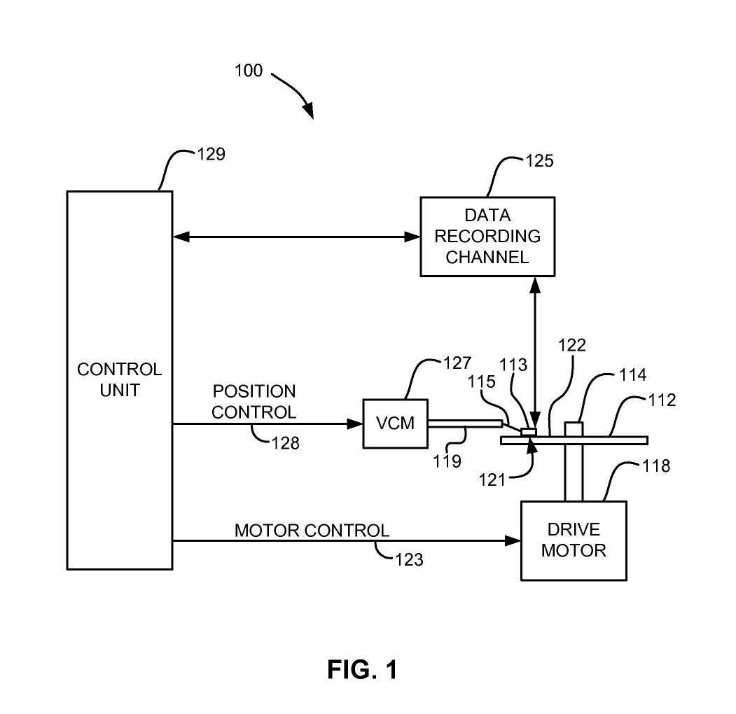

Referring now to FIG. 1, there is shown a disk drive 100 in accordance with one embodiment of the present invention. As shown in FIG. 1, at least one rotatable magnetic medium (e.g., magnetic disk) 112 is supported on a spindle 114 and rotated by a drive mechanism, which may include a disk drive motor 118. The magnetic recording on each disk is typically in the form of an annular pattern of concentric data tracks (not shown) on the disk 112. Thus, the disk drive motor 118 preferably passes the magnetic disk 112 over the magnetic read/write portions 121, described immediately below.

At least one slider 113 is positioned near the disk 112, each slider 113 supporting one or more magnetic read/write portions 121, e.g., of a magnetic head according to any of the approaches described and/or suggested herein. As the disk rotates, slider 113 is moved radially in and out over disk surface 122 so that portions 121 may access different tracks of the disk where desired data are recorded and/or to be written. Each slider 113 is attached to an actuator arm 119 by means of a suspension 115. The suspension 115 provides a slight spring force which biases slider 113 against the disk surface 122. Each actuator arm 119 is attached to an actuator 127. The actuator 127 as shown in FIG. 1 may be a voice coil motor (VCM). The VCM comprises a coil movable within a fixed magnetic field, the direction and speed of the coil movements being controlled by the motor current signals supplied by controller 129.

During operation of the disk storage system, the rotation of disk 112 generates an air bearing between slider 113 and disk surface 122 which exerts an upward force or lift on the slider. The air bearing thus counter-balances the slight spring force of suspension 115 and supports slider 113 off and slightly above the disk surface by a small, substantially constant spacing during normal operation. Note that in some embodiments, the slider 113 may slide along the disk surface 122.

The various components of the disk storage system are controlled in operation by control signals generated by controller 129, such as access control signals and internal clock signals. Typically, control unit 129 comprises logic control circuits, storage (e.g., memory), and a microprocessor. In a preferred approach, the control unit 129 is electrically coupled (e.g., via wire, cable, line, etc.) to the one or more magnetic read/write portions 121, for controlling operation thereof. The control unit 129 generates control signals to control various system operations such as drive motor control signals on line 123 and head position and seek control signals on line 128. The control signals on line 128 provide the desired current profiles to optimally move and position slider 113 to the desired data track on disk 112. Read and write signals are communicated to and from read/write portions 121 by way of recording channel 125.

The above description of a magnetic disk storage system, and the accompanying illustration of FIG. 1 is for representation purposes only. It should be apparent that disk storage systems may contain a large number of disks and actuators, and each actuator may support a number of sliders.

An interface may also be provided for communication between the disk drive and a host (integral or external) to send and receive the data and for controlling the operation of the disk drive and communicating the status of the disk drive to the host, all as will be understood by those of skill in the art.

Regarding a magnetic head, an inductive write portion therein includes a coil layer embedded in one or more insulation layers (insulation stack), the insulation stack being located between first and second pole piece layers. A gap may be formed between the first and second pole piece layers by a gap layer at an air bearing surface (ABS) of the write portion. The pole piece layers may be connected at a back gap. Currents are conducted through the coil layer, which produce magnetic fields in the pole pieces. The magnetic fields fringe across the gap at the ABS for the purpose of writing bits of magnetic field information in tracks on moving media, such as in tracks on a rotating magnetic disk.

The second pole piece layer has a pole tip portion which extends from the ABS to a flare point and a yoke portion which extends from the flare point to the back gap. The flare point is where the second pole piece begins to widen (flare) to form the yoke. The placement of the flare point directly affects the magnitude of the magnetic field produced to write information on the recording medium.

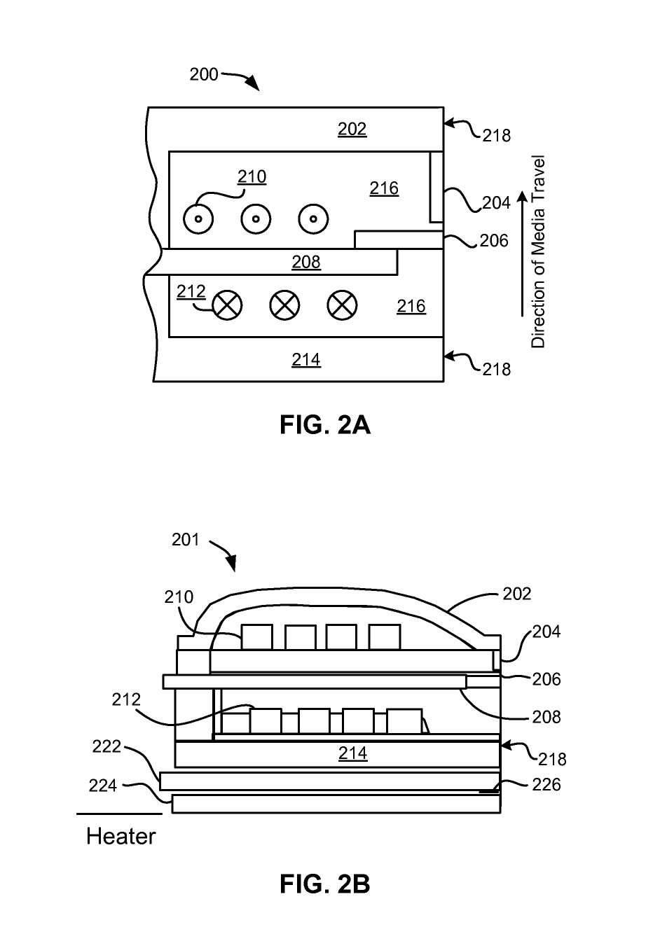

FIG. 2A is a cross-sectional view of a perpendicular magnetic head 200, according to one embodiment. In FIG. 2A, helical coils 210 and 212 are used to create magnetic flux in the stitch pole 208, which then delivers that flux to the main pole 206. Coils 210 indicate coils extending out from the page, while coils 212 indicate coils extending into the page. Stitch pole 208 may be recessed from the ABS 218. Insulation 216 surrounds the coils and may provide support for some of the elements. The direction of the media travel, as indicated by the arrow to the right of the structure, moves the media past the lower return pole 214 first, then past the stitch pole 208, main pole 206, trailing shield 204 which may be connected to the wrap around shield (not shown), and finally past the upper return pole 202. Each of these components may have a portion in contact with the ABS 218. The ABS 218 is indicated across the right side of the structure.

Perpendicular writing is achieved by forcing flux through the stitch pole 208 into the main pole 206 and then to the surface of the disk positioned towards the ABS 218.

FIG. 2B illustrates one embodiment of a piggyback magnetic head 201 having similar features to the head 200 of FIG. 2A. As shown in FIG. 2B, two shields 204, 214 flank (the stitch pole 208 and main pole 206. Also sensor shields 222, 224 are shown. The sensor 226 is typically positioned between the sensor shields 222, 224.

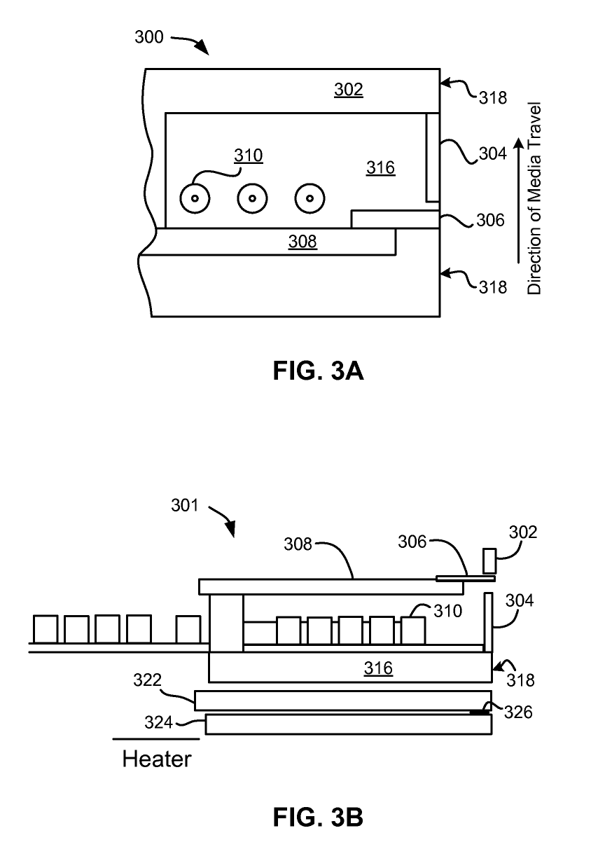

FIG. 3A is a schematic diagram of another embodiment of a perpendicular magnetic head 300, which uses looped coils 310 to provide flux to the stitch pole 308, a configuration that is sometimes referred to as a pancake configuration. The stitch pole 308 provides the flux to the main pole 306. With this arrangement, the lower return pole may be optional. Insulation 316 surrounds the coils 310, and may provide support for the stitch pole 308 and main pole 306. The stitch pole may be recessed from the ABS 318. The direction of the media travel, as indicated by the arrow to the right of the structure, moves the media past the stitch pole 308, main pole 306, trailing shield 304 which may be connected to the wrap around shield (not shown), and finally past the upper return pole 302 (all of which may or may not have a portion in contact with the ABS 318). The ABS 318 is indicated across the right side of the structure. The trailing shield 304 may be in contact with the main pole 306 in some embodiments.

FIG. 3B illustrates another embodiment of a piggyback magnetic head 301 having similar features to the head 300 of FIG. 3A. As shown in FIG. 3B, the piggyback magnetic head 301 also includes a looped coil 310, which wraps around to form a pancake coil. Sensor shields 322, 324 are additionally shown. The sensor 326 is typically positioned between the sensor shields 322, 324.

In FIGS. 2B and 3B, an optional heater is shown near the non-ABS side of the magnetic head. A heater (Heater) may also be included in the magnetic heads shown in FIGS. 2A and 3A. The position of this heater may vary based on design parameters such as where the protrusion is desired, coefficients of thermal expansion of the surrounding layers, etc.

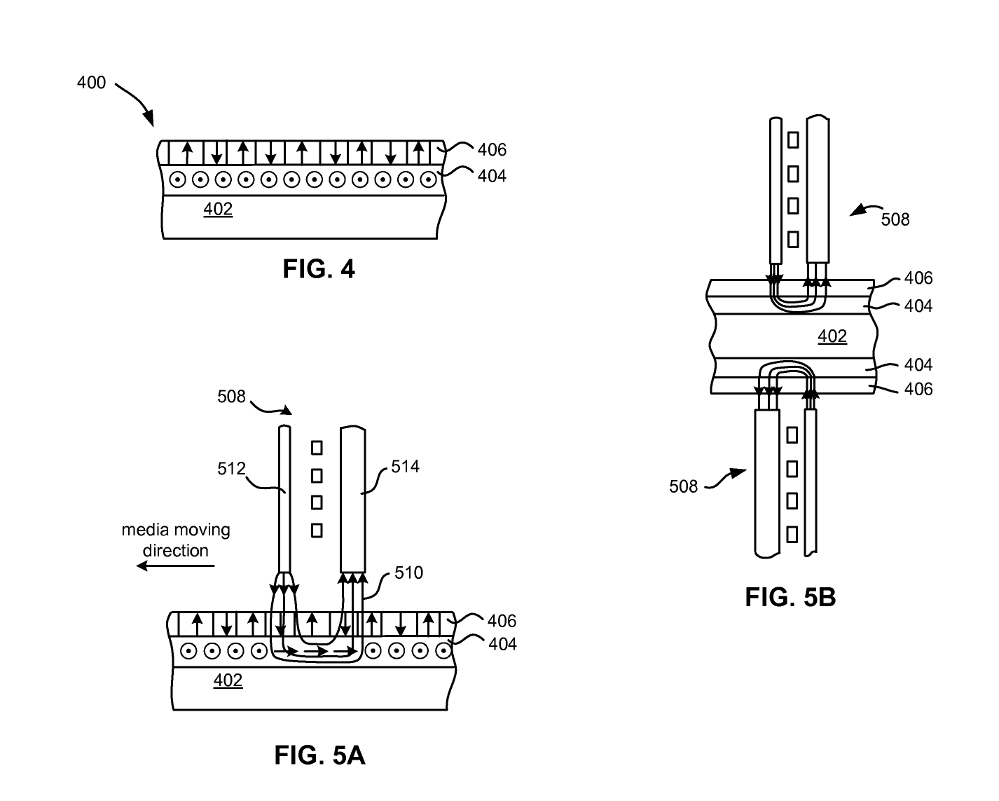

FIG. 4 provides a schematic diagram of a simplified perpendicular recording medium 400, which may also be used with magnetic disk recording systems, such as that shown in FIG. 1. As shown in FIG. 4, the perpendicular recording medium 400, which may be a recording disk in various approaches, comprises at least a supporting substrate 402 of a suitable non-magnetic material (e.g., glass, aluminum, etc.), and a soft magnetic underlayer 404 of a material having a high magnetic permeability positioned above the substrate 402. The perpendicular recording medium 400 also includes a magnetic recording layer 406 positioned above the soft magnetic underlayer 404, where the magnetic recording layer 406 preferably has a high coercivity relative to the soft magnetic underlayer 404. There may one or more additional layers (not shown), such as an “exchange-break” layer or “interlayer”, between the soft magnetic underlayer 404 and the magnetic recording layer 406.

The orientation of magnetic impulses in the magnetic recording layer 406 is substantially perpendicular to the surface of the recording layer. The magnetization of the soft magnetic underlayer 404 is oriented in (or parallel to) the plane of the soft underlayer 404. As particularly shown in FIG. 4, the in-plane magnetization of the soft magnetic underlayer 404 may be represented by an arrow extending into the paper.

FIG. 5A illustrates the operative relationship between a perpendicular head 508 and the perpendicular recording medium 400 of FIG. 4. As shown in FIG. 5A, the magnetic flux 510, which extends between the main pole 512 and return pole 514 of the perpendicular head 508, loops into and out of the magnetic recording layer 406 and soft magnetic underlayer 404. The soft magnetic underlayer 404 helps focus the magnetic flux 510 from the perpendicular head 508 into the magnetic recording layer 406 in a direction generally perpendicular to the surface of the magnetic medium. Accordingly, the intense magnetic field generated between the perpendicular head 508 and the soft magnetic underlayer 404, enables information to be recorded in the magnetic recording layer 406. The magnetic flux is further channeled by the soft magnetic underlayer 404 back to the return pole 514 of the head 508.

As noted above, the magnetization of the soft magnetic underlayer 404 is oriented in (parallel to) the plane of the soft magnetic underlayer 404, and may represented by an arrow extending into the paper. However, as shown in FIG. 5A, this in plane magnetization of the soft magnetic underlayer 404 may rotate in regions that are exposed to the magnetic flux 510.

FIG. 5B illustrates one embodiment of the structure shown in FIG. 5A, where soft magnetic underlayers 404 and magnetic recording layers 406 are positioned on opposite sides of the substrate 402, along with suitable recording heads 508 positioned adjacent the outer surface of the magnetic recording layers 406, thereby allowing recording on each side of the medium.

Except as otherwise described herein with reference to the various inventive embodiments, the various components of the structures of FIGS. 1-5B, and of other embodiments disclosed herein, may be of conventional material(s), design, and/or fabricated using conventional techniques, as would become apparent to one skilled in the art upon reading the present disclosure.

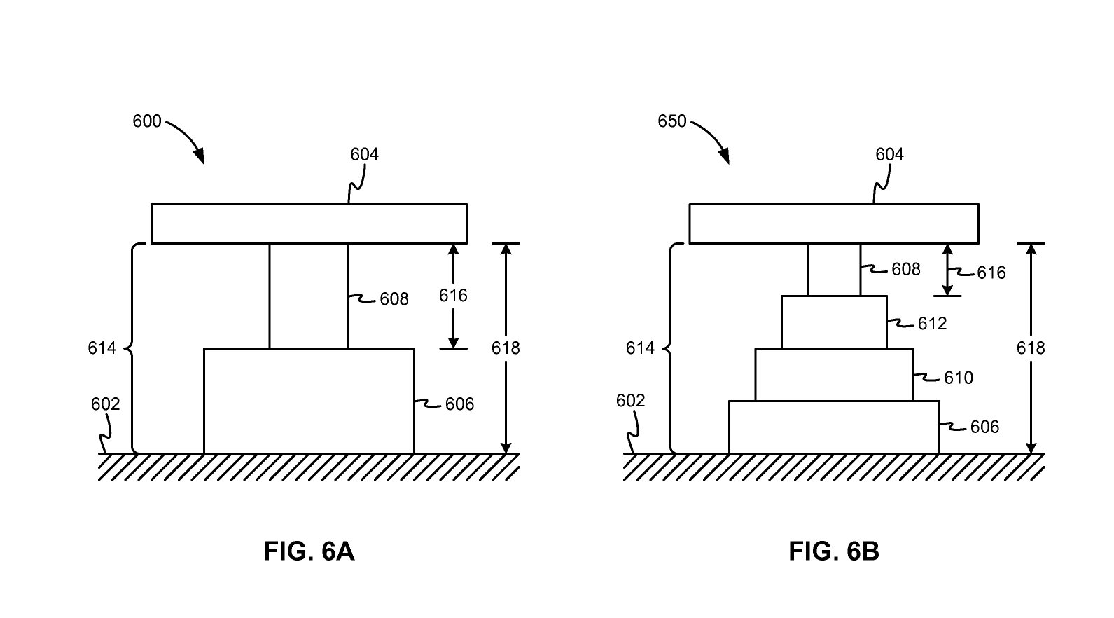

Now referring to FIG. 6A, a cross-sectional side view of a contact pad 600 having a multi-layer stud 614 is shown according to one embodiment. As an option, the present contact pad 600 may be implemented in conjunction with features from any other embodiment listed herein, such as those described with reference to the other figures. Of course, however, such contact pad 600 and others presented herein may be used in various applications and/or in permutations which may or may not be specifically described in the illustrative embodiments listed herein. Further, the contact pad 600 presented herein may be used in any desired environment.

The multi-Layer studs 614 are able to change the geometry of subsequently formed dielectric fill seamlines and possibly stop or minimize propagation of these dielectric fill seamlines to the deposited end surface.

As shown, the multi-layer stud 614 includes two layers, a bottom layer 606 and a top layer 608. The bottom layer 606 is positioned on and extends from an upper surface of a wafer 602 substantially in a direction perpendicular to the upper surface of the wafer 602. The top layer 608 is positioned above the bottom layer 606 and substantially extends in the direction perpendicular to the upper surface of the wafer 602. The direction perpendicular to the upper surface of the wafer 602 is in-line with the arrows depicting the thickness 616 and 618.

The contact pad 600 also includes a cap layer 604 positioned on the top layer 608 of the multi-layer stud 614 and extends beyond sidewalls of the multi-layer stud 614 substantially in a direction parallel with the upper surface of the wafer 602. The direction parallel with the upper surface of the wafer 602 is normal to the arrows depicting the thickness 616 and 618.

The bottom layer 606 may have a larger cross-sectional area than any layer of the multi-layer stud 614 positioned thereabove (such as the top layer 608), in one embodiment. Cross-sectional area is taken in a direction substantially parallel to the upper surface of the wafer 602.

In another embodiment, the cross-sectional area of the bottom layer 606 may be less than a cross-sectional area of the cap layer 604. Again, cross-sectional area is taken in a direction parallel to the upper surface of the wafer 602.

Now referring to FIG. 6B, a cross-sectional side view of a contact pad 650 having a multi-layer stud 614 is shown according to another embodiment. As an option, the present contact pad 650 may be implemented in conjunction with features from any other embodiment listed herein, such as those described with reference to the other figures. Of course, however, such contact pad 650 and others presented herein may be used in various applications and/or in permutations which may or may not be specifically described in the illustrative embodiments listed herein. Further, the contact pad 650 presented herein may be used in any desired environment.

As shown, the multi-layer stud 614 includes four layers, a bottom layer 606, two intermediate layers 610, 612, and a top layer 608. The bottom layer 606 is positioned on and extends from an upper surface of a wafer 602 substantially in a direction perpendicular to the upper surface of the wafer 602. The top layer 608 is positioned above the bottom layer 606 and substantially extends in the direction perpendicular to the upper surface of the wafer 602. The direction perpendicular to the upper surface of the wafer 602 is in-line with the arrows depicting the thickness 616 and 618.

The contact pad 650 also includes a cap layer 604 positioned on the top layer 608 of the multi-layer stud 614 and extends beyond sidewalls of the multi-layer stud 614 substantially in a direction parallel with the upper surface of the wafer 602. The direction parallel with the upper surface of the wafer 602 is normal to the arrows depicting the thickness 616 and 618.

The bottom layer 606 may have a larger cross-sectional area than any layer 608, 610, and 612 of the multi-layer stud 614 positioned thereabove, in one embodiment. Cross-sectional area is taken in a direction parallel to the upper surface of the wafer 602.

Each of the layers 608, 610, and 612 is positioned above the layer(s) therebelow, and has a smaller cross-sectional area than the layer directly therebelow. For example, intermediate layer 612 is positioned above intermediate layer 610 and has a smaller cross-sectional area than intermediate layer 610. Furthermore, each layer is centered as close as possible above the layer(s) therebelow, taking into consideration manufacturing tolerances and the precision of the tools and processes used in the formation of the layers 606, 608, 610, and 612.

In another embodiment, the cross-sectional area of the bottom layer 606 may be less than a cross-sectional area of the cap layer 604. Again, cross-sectional area is taken in a direction parallel to the upper surface of the wafer 602.

In a further embodiment, the cross-sectional area of the top layer 608 of the multi-layer stud of each contact pad may be no more than half the cross-sectional area of the bottom layer 606 of the multi-layer stud of each contact pad. In this way, the cross-sectional area of the bottom layer 606 is at least double the cross-sectional area of the top layer 608 of the multi-layer stud of each contact pad.

Of course, in other embodiments, the number of layers which comprise the multi-layer studs may be increased or decreased from that shown in FIGS. 6A-6B so that more or less layers than the two layers shown in FIG. 6A or the four layers shown in FIG. 6B may be used to construct the multi-layer stud 614. Furthermore, in each of these multi-layer studs 614, different materials, thicknesses, cross-sectional surface areas, and shapes may be used than are explicitly shown in the various figures contained herein.

In one embodiment, the thickness 616, in the direction perpendicular to the upper surface of the wafer 602, of the top layer 608 of the multi-layer stud 614 of each contact pad may be in a range from about 5 μm to about 15 μm, such as about 10 μm in one approach. Furthermore, the total thickness 618, in the direction perpendicular to the upper surface of the wafer 602, of the multi-layer stud 614 of each contact pad may be in a range from about 30 μm to about 50 μm, such as about 35 μm in one approach.

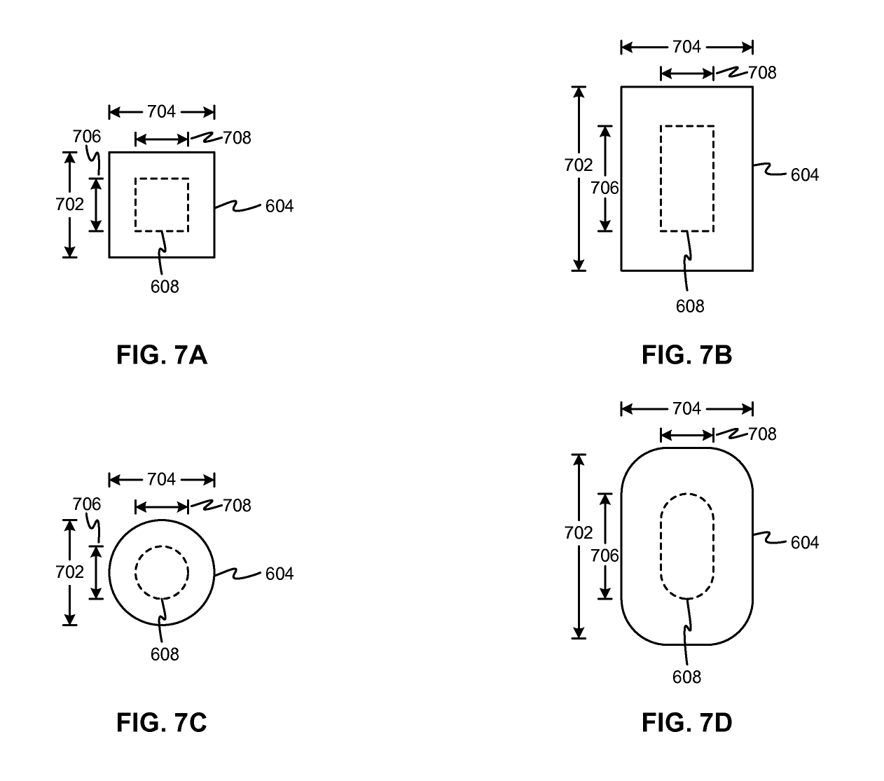

Now referring to FIGS. 7A-7D, various cap layer 604 and top layer 608 cross-sectional top profiles are shown in multiple embodiments. As shown in FIG. 7A, in one embodiment, the cap layer 604 and the top layer 608 may have a square or substantially square cross-sectional profile, with the cross-sectional area of the cap layer 604 being greater than the cross-sectional area of the top layer 608 by a factor in a range from about 2 to about 6, in various approaches. That is to say, the cross-sectional area of the top layer 608 may be, at the most, equal to about one half of the cross-sectional area of the cap layer 604 in one approach.

Now referring to FIG. 7B, in one embodiment, the cap layer 604 and the top layer 608 may have a rectangular or substantially rectangular cross-sectional profile, with the cross-sectional area of the cap layer 604 being greater than the cross-sectional area of the top layer 608 by a factor in a range from about 2 to about 6, in various approaches. That is to say, the cross-sectional area of the top layer 608 may be, at the most, equal to about one half of the cross-sectional area of the cap layer 604 in one approach.

Now referring to FIG. 7C, in one embodiment, the cap layer 604 and the top layer 608 may have a circular or substantially circular cross-sectional profile, with the cross-sectional area of the cap layer 604 being greater than the cross-sectional area of the top layer 608 by a factor in a range from about 2 to about 6, in various approaches. That is to say, the cross-sectional area of the top layer 608 may be, at the most, equal to about one half of the cross-sectional area of the cap layer 604 in one approach.

Now referring to FIG. 7D, in one embodiment, the cap layer 604 and the top layer 608 may have an oval or substantially oval cross-sectional profile, with the cross-sectional area of the cap layer 604 being greater than the cross-sectional area of the top layer 608 by a factor in a range from about 2 to about 6, in various approaches. That is to say, the cross-sectional area of the top layer 608 may be, at the most, equal to about one half of the cross-sectional area of the cap layer 604 in one approach.

Of course, any other cross-sectional profiles may be used for the cap layer 604 and the top layer 608, such as triangular, hexagonal, parallelogram, trapezoid, polygonal, rounded-corner, etc. Furthermore, in some embodiments, the cross-sectional profile of the cap layer 604 may be different (not just in size) from the cross-sectional profile of the top layer 608.

Referring again to FIGS. 7A-7D, in one embodiment, a width 702 or 704 of the cap layer 604 may be greater than or equal to a width 706 or 708 of the top layer 608. The widths 702, 704, 706, and 708 are all taken in a direction parallel to the upper surface of the wafer.

In a further approach, a width (W_{CL}) 702 or 704 of the cap layer 604 may be greater than or equal to a width (W_{TL}) 706 or 708 of the top layer 608 plus a thickness (T_{TL}) (thickness 616 of FIG. 6) of the top layer 608. The thickness 616 is taken in the direction perpendicular to the upper surface of the wafer 602. Specifically, W_{CL}≧W_{TL}+T_{TL}.

In one embodiment, the cross-sectional area of the top layer 608 of the multi-layer stud of each contact pad may be no more than half the cross-sectional area of the cap layer 604 of each contact pad. In this way, the surface area of the cap layer 604 is at least double the surface area of the top layer 608 of the multi-layer stud of each contact pad.

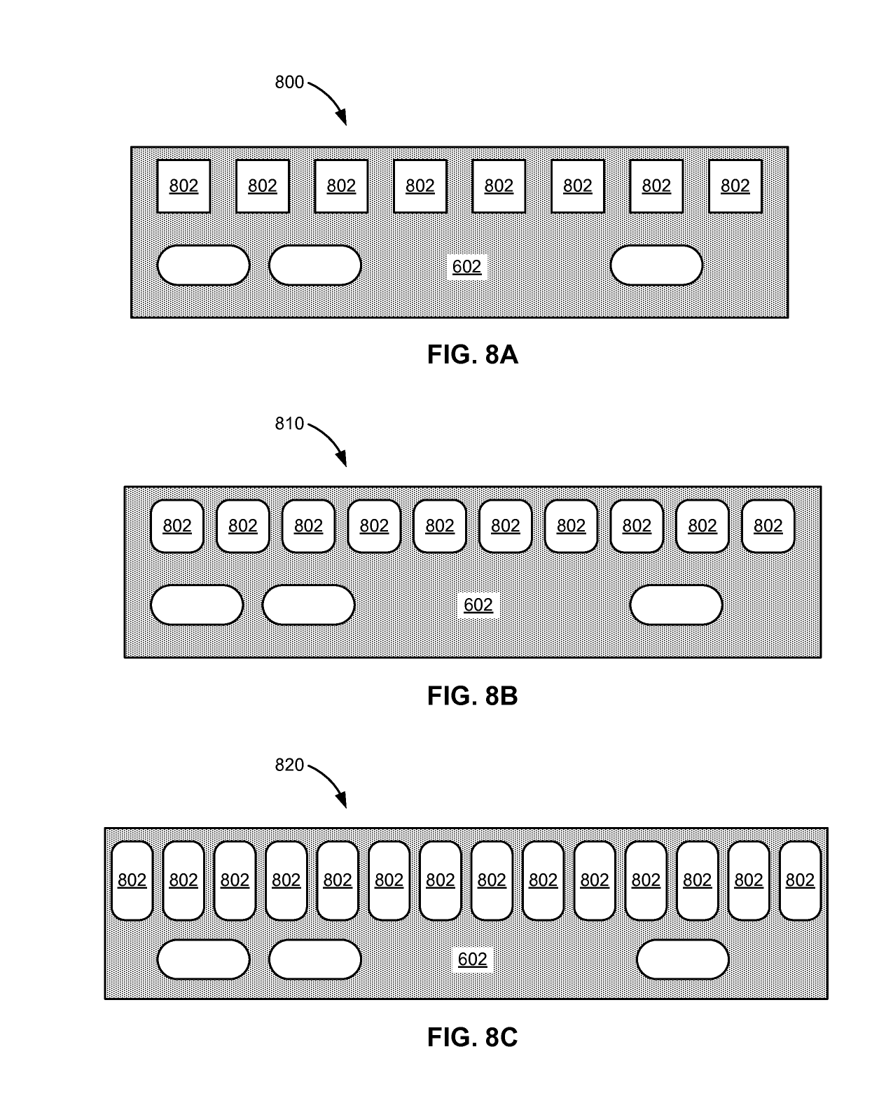

FIGS. 8A-8C show systems 800, 810, 820 with exemplary contact pad layouts, each system having a different number of contact pads. As an option, the present systems 800, 810, 820 may be implemented in conjunction with features from any other embodiment listed herein, such as those described with reference to the other figures. Of course, however, such systems 800, 810, 820 and others presented herein may be used in various applications and/or in permutations which may or may not be specifically described in the illustrative embodiments listed herein. Further, the systems 800, 810, 820 presented herein may be used in any desired environment.

Furthermore, each system 800, 810, 820 comprises a wafer 602 and a plurality of contact pads 802 positioned on the wafer 602. In one embodiment, the plurality of contact pads 802 positioned on the wafer 602 numbers 10 or more.

In FIG. 8A, a system 800 having eight contact pads 802 is shown according to one embodiment, with the contact pads each having a square profile cap layer. In FIG. 8B, a system 810 having ten contact pads 802 is shown according to one embodiment, with the contact pads each having a rounded-corner square profile cap layer. In FIG. 8C, a system 820 having fourteen contact pads 802 is shown according to one embodiment, with the contact pads each having a rounded-corner rectangular profile cap layer. Of course, more than fourteen and less than eight contact pads 802 may be included in each system, which may be in the form of a slider or some other electronics layout as known in the art.

According to one embodiment, a magnetic data storage system comprises at least one magnetic head comprising a slider according to the system as shown in any of FIGS. 8A-8C. The magnetic data storage system also comprises a magnetic medium, a drive mechanism for passing the magnetic medium over the at least one magnetic head, and a controller electrically coupled to the at least one magnetic head for controlling operation of the at least one magnetic head.

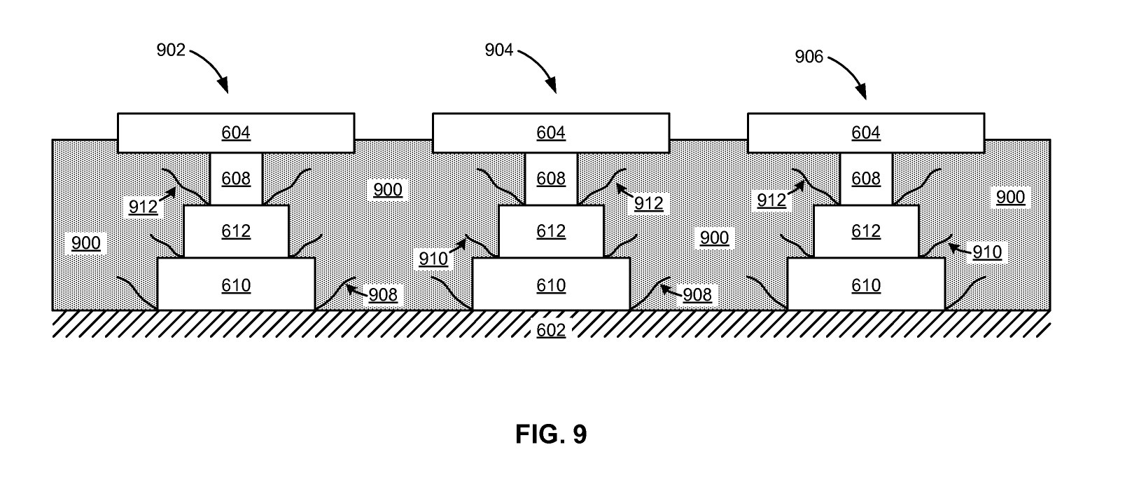

Now referring to FIG. 9, a cross-sectional side view of three contact pads is shown, according to one embodiment. As an option, the contact pads may be implemented in conjunction with features from any other embodiment listed herein, such as those described with reference to the other figures. Of course, however, such contact pads and others presented herein may be used in various applications and/or in permutations which may or may not be specifically described in the illustrative embodiments listed herein. Further, the contact pads presented herein may be used in any desired environment.

As shown, a dielectric layer 900 is positioned above the wafer 602 and between each contact pad 902, 904, 906. Seamlines of the dielectric layer are also shown, with seamlines being positioned at the intersection of the various layers of the multi-layer studs and the dielectric layer 900. Three-layer studs are shown, but any number of layers two or more may be used in various approaches, with each layer being associated with a seamline in the dielectric layer 900.

Moreover, in one approach, the multi-layer stud of each contact pad 902, 904, 906 may comprise three or more layers.

As shown, bottom layer 610, after being formed, is back-filled with the dielectric layer 900, resulting in a shadow effect that forms seamlines 908 for each stud that exist in the dielectric layer 900 and that propagate out from the bottom of the sidewalls of each stud layer, e.g., 610, 612, 608.

For example, after formation of the intermediate layer 612, the dielectric layer 900 may be back-filled or otherwise formed, which results in shadowing that forms seamlines 910 in the dielectric layer 900 that extend out from the sidewalls of each stud. Thereafter, top layer 608 is formed, and then the dielectric layer 900 may be back-filled or otherwise formed resulting in shadowing that forms seamlines 912 that extend out from the sidewalls of each stud. Any of these seamlines 908, 910, 912, conventionally, may result in corrosion being introduced into the material of the studs, as oxygen or other corrosion inducing elements may follow the seamlines down to the sidewalls of the layers of the studs. Moreover, these seamlines may propagate cracks and other structural integrity issues for the contact pads 902, 904, 906. In addition, these seamlines produce a trailing edge alumina defect (TEAD) reliability risk for the contact pads 902, 904, 906.

Furthermore, TEAD appears to be caused not only by a solder ball jet (SB-jet) formation process, which is used to form the cap layer for each contact pad, but also in the wafer process. The energy provided by the SB-jet process actually causes the seamlines to propagate into small to large cracks in the dielectric layer, thereby allowing negative effects to occur due to the lack of proper insulation of the studs.

Furthermore, multi-layer studs are able to eliminate extra CMP and fill processing used in certain advanced head design manufacturing due to a thicker dielectric overcoat, such as for heat-assisted magnetic recording (HAMR). Multi-layer studs may also enable higher packing density in wafer designs, allowing for more contact pads on each wafer (and slider).

Also, when seamlines in the dielectric layer 900 cross each other, voids are created and these voids have the ability to trap material used in the cap layer 604 formation, such as during formation of a seed layer for plating. This trapped material may cause pad-to-pad shorts, which renders the contact pads useless and/or unreliable.

However, as shown in FIG. 9, seamlines 912 of a portion of the dielectric layer 900 around the top layer 608 of the multi-layer stud of each contact pad 902, 904, 906 do not extend beyond sidewalls of the cap layer 604 of each contact pad 902, 904, 906 in the direction parallel to the upper surface of the wafer 602. It has been found that covering the seamlines in this way eliminates the chance for corrosion, cracks, TEAD, and the other negative situations that arise from the seamlines 912, and produces more structurally sound contact pads 902, 904, 906.

In another embodiment, seamlines 908 of portions of the dielectric layer 900 around the bottom layer 610 and seamlines of any layers between the bottom layer 610 and the top layer 608 of the multi-layer stud of each contact pad 902, 904, 906 (e.g., seamlines 910 of intermediate layer 612) do not extend to an upper surface of the dielectric layer 900. Forming the contact pads in this way has also been found to eliminate the chance for corrosion, cracks, TEAD, and the other negative situations that arise from the seamlines 908, 910 and produce more structurally sound contact pads 902, 904, 906.

In one embodiment, the dielectric layer 900 may comprise alumina, MgO, Ta₂O₅, or some other suitable dielectric known in the art.

In one approach, the multi-layer stud (each layer thereof e.g., 610, 612, 608) of each contact pad 902, 904, 906 may comprise copper, silver, gold, alloys thereof, or some other suitable conductive material known in the art.

In one embodiment, the cap layer 604 of each contact pad 902, 904, 906 may comprise gold copper, silver, alloys thereof, or some other suitable conductive material known in the art.

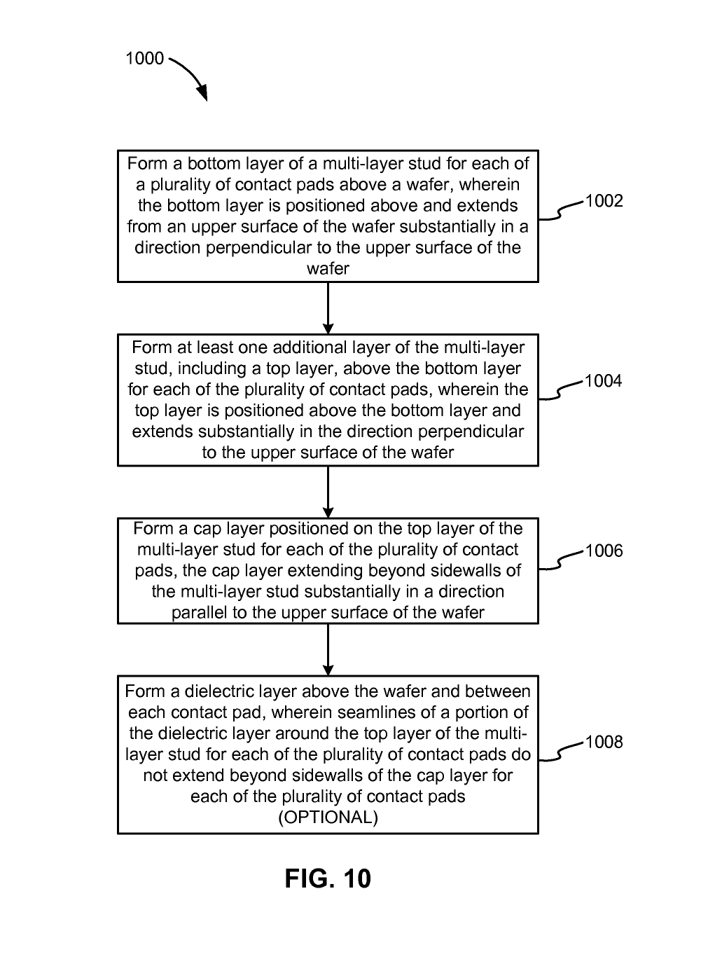

FIG. 10 shows a method 1000 for forming an assembly having a plurality of contact pads in accordance with one embodiment. As an option, the present method 1000 may be implemented to construct structures such as those shown in FIGS. 1-9. Of course, however, method 1000 of FIG. 10 and others presented herein may be used to form magnetic structures for a wide variety of devices and/or purposes which may or may not be related to magnetic recording. Further, the methods presented herein may be carried out in any desired environment. It should also be noted that any aforementioned features may be used in any of the embodiments described in accordance with the various methods.

In operation 1002, a bottom layer of a multi-layer stud is formed for each of a plurality of contact pads above a wafer. The bottom layer is positioned above and extends from an upper surface of the wafer substantially in a direction perpendicular to the upper surface of the wafer. Any suitable thin film formation process and material may be used to form the bottom layer. Exemplary materials include conductive materials, such as metals and metal alloys, that include gold, copper, silver, aluminum, etc. Exemplary formation techniques include plating, sputtering, chemical vapor deposition (CVD), atomic layer deposition (ALD), plasma enhanced CVD (PECVD), etc.

In operation 1004, at least one additional layer of the multi-layer stud is formed, including a top layer, above the bottom layer for each of the plurality of contact pads. The top layer is positioned above the bottom layer and extends substantially in the direction perpendicular to the upper surface of the wafer. Any suitable thin film formation process and material may be used to form the at least one additional layer (including the top layer). Exemplary materials include conductive materials, such as metals and metal alloys that include gold, copper, silver, aluminum, etc. Exemplary formation techniques include plating, sputtering, CVD, ALD, PECVD, etc.

In one embodiment, formation of the multi-layer stud only includes formation of the bottom layer and the top layer only, resulting in a multi-layer stud having two total layers.

In more embodiments, one or more additional layers may be formed between the bottom layer and the top layer, creating a total of three or more layers in each multi-layer stud.

In operation 1006, a cap layer positioned on the top layer of the multi-layer stud is formed for each of the plurality of contact pads. The cap layer extends beyond sidewalls of the multi-layer stud substantially in a direction parallel to the upper surface of the wafer, e.g., sideways from the sidewalls of each of the multi-layer stud, creating a flat mushroom shape for each of the contact pads. Any suitable thin film formation process and material may be used to form the cap layer. Exemplary materials include conductive materials, such as metals and metal alloys that include gold, copper, silver, aluminum, etc. Exemplary formation techniques include plating, sputtering, CVD, ALD, PECVD, etc.

According to one embodiment, the bottom layer has a larger cross-sectional area than any layer of the multi-layer stud positioned thereabove. Furthermore, the cross-sectional area of the bottom layer is less than a cross-sectional area of the cap layer.

In optional operation 1008, which is not required to be performed in each embodiment of method 1000, a dielectric layer is formed above the wafer and between each contact pad. The dielectric layer is formed such that seamlines of a portion of the dielectric layer around the top layer of the multi-layer stud for each of the plurality of contact pads do not extend beyond sidewalls of the cap layer for each of the plurality of contact pads.

In one embodiment, the dielectric layer may comprise alumina. In other embodiments, any suitable dielectric and/or electrically insulative material may be used, such as MgO, Ta₂O₅, etc.

In one approach, the multi-layer stud for each of the plurality of contact pads may comprise copper or an alloy thereof, and the cap layer for each of the plurality of contact pads may comprise gold or an alloy thereof.

In another embodiment, seamlines of portions of the dielectric layer around the bottom layer and any layers between the bottom layer and the top layer of the multi-layer stud for each of the plurality of contact pads do not extend to an upper surface of the dielectric layer, thereby burying these seamlines beneath the dielectric layer positioned thereabove and resisting the negative effects associated with these seamlines detailed herein and known in the art.

According to one embodiment, a thickness, in the direction perpendicular to the upper surface of the wafer, of the top layer of the multi-layer stud for each of the plurality of contact pads may be in a range from about 5 μm to about 15 μm, such as about 10 μm.

In one approach, a thickness, in the direction perpendicular to the upper surface of the wafer, of the multi-layer stud for each of the plurality of contact pads is in a range from about 30 μm to about 50 μm, such as about 35 μm.

In another embodiment, the plurality of contact pads positioned on the wafer may number 8, 10, or more, such as 14 contact pads on each slider.

According to another embodiment, the cross-sectional area of the top layer of the multi-layer stud for each of the plurality of contact pads may be no more than half the cross-sectional area of the cap layer for each of the plurality of contact pads, such as 40%, ⅓, ¼, etc.

In yet another embodiment, the cross-sectional area of the top layer of the multi-layer stud for each of the plurality of contact pads may be no more than half the cross-sectional area of the bottom layer of the multi-layer stud for each of the plurality of contact pads, such as 40%, ⅓, ¼, etc.

In yet another embodiment, a width of the cap layer of the multi-layer stud of each contact pad may be greater than or equal to a thickness plus a width of the top layer of the multi-layer stud of each contact pad. The widths are taken in the direction parallel to the upper surface of the wafer, while the thickness is taken in the direction perpendicular to the upper surface of the wafer.

It should be noted that methodology presented herein for at least some of the various embodiments may be implemented, in whole or in part, in computer hardware, software, by hand, using specialty equipment, etc. and combinations thereof.

Moreover, any of the structures and/or steps may be implemented using known materials and/or techniques, as would become apparent to one skilled in the art upon reading the present specification.

The inventive concepts disclosed herein have been presented by way of example to illustrate the myriad features thereof in a plurality of illustrative scenarios, embodiments, and/or implementations. It should be appreciated that the concepts generally disclosed are to be considered as modular, and may be implemented in any combination, permutation, or synthesis thereof. In addition, any modification, alteration, or equivalent of the presently disclosed features, functions, and concepts that would be appreciated by a person having ordinary skill in the art upon reading the instant descriptions should also be considered within the scope of this disclosure.

While various embodiments have been described above, it should be understood that they have been presented by way of example only, and not limitation. Thus, the breadth and scope of an embodiment of the present invention should not be limited by any of the above-described exemplary embodiments, but should be defined only in accordance with the following claims and their equivalents.

What is claimed is:

1. A system, comprising:
a wafer; and
a plurality of contact pads positioned on the wafer, each contact pad comprising:
a multi-layer stud comprising at least a bottom layer and a top layer, the bottom layer being positioned on and extending from an upper surface of the wafer substantially in a direction perpendicular to the upper surface of the wafer, and the top layer being positioned above the bottom layer and substantially extending in the direction perpendicular to the upper surface of the wafer; and
a cap layer positioned on the top layer of the multi-layer stud and extending beyond sidewalls of the multi-layer stud substantially in a direction parallel to the upper surface of the wafer,
wherein the bottom layer has a larger cross-sectional area than any layer of the multi-layer stud positioned thereabove.

2. The system as recited in claim 1, further comprising a dielectric layer positioned above the wafer and between each contact pad, wherein seamlines of a portion of the dielectric layer around the top layer of the multi-layer stud of each contact pad do not extend beyond sidewalls of the cap layer of each contact pad in the direction parallel to the upper surface of the wafer.

3. The system as recited in claim 2, wherein seamlines of portions of the dielectric layer around the bottom layer and any layers between the bottom layer and the top layer of the multi-layer stud of each contact pad do not extend to an upper surface of the dielectric layer.

4. The system as recited in claim 1, wherein the cross-sectional area of the bottom layer of the multi-layer stud of each contact pad is less than a cross-sectional area of the cap layer of each contact pad.

5. The system as recited in claim 1, wherein a thickness, in the direction perpendicular to the upper surface of the wafer, of the top layer of the multi-layer stud of each contact pad is in a range from about 5 μm to about 15 μm, and wherein a thickness, in the direction perpendicular to the upper surface of the wafer, of the multi-layer stud of each contact pad is in a range from about 30 μm to about 50 μm.

6. The system as recited in claim 1, wherein the multi-layer stud of each contact pad comprises three or more layers.

7. The system as recited in claim 1, wherein the plurality of contact pads positioned on the wafer numbers 10 or more.

8. The system as recited in claim 1, wherein a cross-sectional area of the top layer of the multi-layer stud of each contact pad is no more than half a cross-sectional area of the cap layer of each contact pad.

9. The system as recited in claim 1, wherein a cross-sectional area of the top layer of the multi-layer stud of each contact pad is no more than half the cross-sectional area of the bottom layer of the multi-layer stud of each contact pad.

10. The system as recited in claim 1, wherein a width, in the direction parallel to the upper surface of the wafer, of the cap layer of the multi-layer stud of each contact pad is greater than or equal to a thickness, in the direction perpendicular to the upper surface of the wafer, plus a width, in the direction parallel to the upper surface of the wafer, of the top layer of the multi-layer stud of each contact pad.

11. A magnetic data storage system, comprising:
at least one magnetic head comprising a slider according to the system as recited in claim 1;
a magnetic medium;
a drive mechanism for passing the magnetic medium over the at least one magnetic head; and
a controller electrically coupled to the at least one magnetic head for controlling operation of the at least one magnetic head.

12. A method, comprising:
forming a bottom layer of a multi-layer stud for each of a plurality of contact pads above a wafer, wherein the bottom layer is positioned above and extends from an upper surface of the wafer substantially in a direction perpendicular to the upper surface of the wafer;
forming at least one additional layer of the multi-layer stud, including a top layer, above the bottom layer for each of the plurality of contact pads, wherein the top layer is positioned above the bottom layer and extends substantially in the direction perpendicular to the upper surface of the wafer; and
forming a cap layer positioned on the top layer of the multi-layer stud for each of the plurality of contact pads, the cap layer extending beyond sidewalls of the multi-layer stud substantially in a direction parallel to the upper surface of the wafer,
wherein the bottom layer has a larger cross-sectional area than any layer of the multi-layer stud positioned thereabove.

13. The method as recited in claim 12, further comprising forming a dielectric layer above the wafer and between each contact pad, wherein seamlines of a portion of the dielectric layer around the top layer of the multi-layer stud for each of the plurality of contact pads do not extend beyond sidewalls of the cap layer for each of the plurality of contact pads.

14. The method as recited in claim 13, wherein seamlines of portions of the dielectric layer around the bottom layer and any layers between the bottom layer and the top layer of the multi-layer stud for each of the plurality of contact pads do not extend to an upper surface of the dielectric layer.

15. The method as recited in claim 12, wherein the cross-sectional area of the bottom layer is less than a cross-sectional area of the cap layer.

16. The method as recited in claim 12, wherein a thickness, in the direction perpendicular to the upper surface of the wafer, of the top layer of the multi-layer stud for each of the plurality of contact pads is in a range from about 5 μm to about 15 μm, and wherein a thickness, in the direction perpendicular to the upper surface of the wafer, of the multi-layer stud for each of the plurality of contact pads is in a range from about 30 μm to about 50 μm.

17. The method as recited in claim 12, wherein the multi-layer stud for each of the plurality of contact pads comprises three or more layers, wherein the plurality of contact pads positioned on the wafer numbers 10 or more.

18. The method as recited in claim 12, wherein a cross-sectional area of the top layer of the multi-layer stud for each of the plurality of contact pads is no more than half a cross-sectional area of the cap layer for each of the plurality of contact pads.

19. The method as recited in claim 12, wherein a cross-sectional area of the top layer of the multi-layer stud for each of the plurality of contact pads is no more than half the cross-sectional area of the bottom layer of the multi-layer stud for each of the plurality of contact pads.

20. The method as recited in claim 12, wherein a width, in the direction parallel to the upper surface of the wafer, of the cap layer of the multi-layer stud of each contact pad is greater than or equal to a thickness, in the direction perpendicular to the upper surface of the wafer, plus a width, in the direction parallel to the upper surface of the wafer, of the top layer of the multi-layer stud of each contact pad.
